(19) United States
(12) Patent Application Publication
(10) Pub. No.: US 2026/0225128 A1
(43) Pub. Date: Aug. 6, 2026

(54) CAULKING DEVICE

(71) Applicant: Slavomir Stasko, Farmington, NY (US)

(72) Inventor: Slavomir Stasko, Farmington, NY (US)

(21) Appl. No.: 19/046,346

(22) Filed: Feb. 5, 2025

(51) Int. Cl. B05C 17/005; B05C 17/01

(52) U.S. Cl. CPC B05C 17/00589; B05C 17/01

(57) ABSTRACT

A caulking device includes a caulk dispenser comprising a caulk container holding body and a dispensing mechanism. The caulk container holding body is adapted to receive a caulk container, and the dispensing mechanism is adapted to cause caulk within the caulk container to be dispensed from the caulk container when the dispensing mechanism is actuated. The caulking device also has a supporting mechanism connected to the caulk container holding body. The supporting mechanism is adapted to contact a surface onto which caulk is to be applied and to orient the caulk dispenser at a predetermined and consistent angle of tilt during the dispensing of the caulk. In one version, the supporting mechanism includes a propelling mechanism adapted to cause the caulking device to move in a direction of the application of caulk on the surface.

### BACKGROUND

The application of caulk in a home improvement and/or a construction project can be a messy task and one that is difficult to master.

Caulk is a flexible material used for many purposes. For example, caulk can be used to seal gaps, such as joints or seams, and/or can be used as an adhesive to join two or more objects together. Most often, caulk is applied to an area where a gap would otherwise allow the unwanted passage of water, air, dust, insects, or the like. For example, caulk is commonly applied around windows, around bathroom, kitchen, and utility room fixtures, basins, and tubs, as tile grout or along the edges of tiled surfaces. Caulks comprise one or more sealing and/or adhesive compounds, such as acrylic, acrylic latex, polyurethane, silicone, and the like. To apply caulk, it is squeezed from a container in a relatively flexible, uncured condition. After application, the caulk is exposed to air and caused to cure into a relatively hardened condition where it can last for years before needing to be replaced.

A conventional caulk container is a hard-walled tube or cartridge that is inserted into a caulking gun for application. The tube has a tapered front tip on its front end that can be opened or cut and a displaceable rear wall that can be moved by the caulking gun, to push caulk out of the front opening. The process itself is not difficult but creating a nice, clean line of caulk or bead in a short amount of time takes much experience to master. This is particularly true when a user needs to create a long straight line of caulk in an area that is highly viewable. To make such a line, a steady constant pressure must be applied from the caulking gun, and the user must move the caulking gun on a straight line and at a consistent angle and constant speed. A conventional caulking gun is operated by a ratcheted trigger that must be manually squeezed with little assurance of constant pressure being applied by the caulking gun. Also, a single wrong movement, such as a misdirection, jerk, or change of speed, can result in a less-than-ideal caulk line or bead, which can require repair or redo. Much of the time, a user must use a finger or tool to smooth the line of caulk after application. In addition, the constant application of pressure on the trigger can cause hand fatigue.

Motorized caulking guns have been developed to help with the application of a constant pressure. When a trigger is depressed, a motor applies a force against the moveable rear of the caulk container. Motorized caulking guns can help evenly disperse the caulk, reduce hand fatigue, and prevent overflow when application is paused. However, motorized caulking guns are heavier than conventional non-motorized caulking guns which can lead to fatigue, especially when used for a long period of time, such as at a construction site. In addition, motorized caulking guns offer no assistance in maintaining a consistent angle and no protection against erratic or inconsistent movement and can, in actuality, be more problematic because of their increased weight and size.

Therefore, there is a need for an improved caulking device. There is a further need for a caulking device that can help provide an improved line or bead of caulk. There is a further need for a caulking device that can help provide an improved bead of caulk with reduced time and user effort. There is a further need for a caulking device that can ease the task of supporting the caulking gun. There is a further need for a caulking device that can be more easily and controllably moved at a consistent speed.

### SUMMARY

The present invention satisfies one or more of these needs. In one aspect of the invention, an improved caulking device is provided.

In another aspect of the invention, a caulking device is provided that can provide an improved and/or more consistent line of caulk.

In another aspect of the invention, a caulking device is provided that can help provide an improved bead of caulk with reduced time and user effort.

In another aspect of the invention, a caulking device is provided that can ease the task of supporting the caulking gun.

In another aspect of the invention, a caulking device is provided that can be more easily and controllably moved at a consistent speed.

In another aspect of the invention, a caulking device is provided that includes a supporting mechanism.

In another aspect of the invention, a caulking device is provided that includes a supporting mechanism that can help maintain the caulking device at a consistent angle of tilt.

In another aspect of the invention, a caulking device is provided that includes a supporting mechanism that can help maintain the caulking device at a consistent angle of tilt in a direction of the application of the caulk.

In another aspect of the invention, a caulking device is provided that includes a supporting mechanism that can help maintain the caulking device at a consistent angle of tilt in a direction lateral to the direction of the application of caulk.

In another aspect of the invention, a caulking device is provided that includes a supporting mechanism that is propelled and/or motorized.

In another aspect of the invention, a self-propelled caulking device is provided.

In another aspect of the invention, a method of dispensing caulk comprises providing a caulking device as described herein and using the caulking device as described herein.

In another aspect of the invention, a caulking device comprises a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and a supporting mechanism connected to the caulk container holding body, the supporting mechanism comprising a surface contacting member adapted to contact a surface onto which caulk is to be applied, wherein the support mechanism is adapted to orient the caulk dispenser at a predetermined and consistent angle of tilt during the dispensing of the caulk.

In another aspect of the invention, a caulking device comprises a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and a supporting mechanism connected to the caulk container holding body, the supporting mechanism comprising a surface contacting member adapted to contact a surface onto which caulk is to be applied, wherein the support mechanism is adapted to orient the caulk dispenser at a predetermined and consistent angle of tilt during the dispensing of the caulk, wherein the supporting mechanism comprises a wheel.

In another aspect of the invention, a caulking device comprises a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and a supporting mechanism connected to the caulk container holding body, the supporting mechanism comprising a surface contacting member adapted to contact a surface onto which caulk is to be applied, wherein the support mechanism is adapted to orient the caulk dispenser at a predetermined and consistent angle of tilt during the dispensing of the caulk, wherein the supporting mechanism comprises a caulking device propelling mechanism adapted to cause the caulking device to move relative to a surface in the direction of the application of caulk on the surface.

In another aspect of the invention, a caulking device comprises a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and a propelling mechanism adapted to cause the caulking device to move relative to a surface onto which caulk is to be dispensed from the caulking device, wherein the propelling mechanism causes the caulking device to move in the direction of the application of caulk on the surface.

In another aspect of the invention, a caulking device comprises a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and a propelling mechanism adapted to cause the caulking device to move relative to a surface onto which caulk is to be dispensed from the caulking device, wherein the propelling mechanism causes the caulking device to move in the direction of the application of caulk on the surface, wherein the caulking device propelling mechanism comprises a wheel and a motor adapted to cause the wheel to rotate.

In another aspect of the invention, a method of applying caulk to a surface comprises providing a caulking device comprising a caulk dispenser and a supporting mechanism connected to the caulk dispenser, wherein the caulk dispenser comprises a caulk container holding body and a dispensing mechanism; loading a caulk container into the caulk container holding body; activating the dispensing mechanism to cause caulk to be dispensed out of the caulk container and applied onto the surface; contacting the surface with the supporting mechanism to support the caulking device on the surface and to maintain a consistent angle of tilt during the application of caulk onto the surface.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic side view of a version of a caulking device of the invention in an unloaded condition;

FIG. 1B is a schematic side view of the caulking device of FIG. 1 in a loaded condition;

FIG. 2 is a schematic side view of the caulking device of FIGS. 1A and 1B in use on a flat surface;

FIG. 3 is a schematic perspective view of the caulking device of FIGS. 1A and 1B in use on a flat surface;

FIG. 4 is schematic bottom view of the caulking device of FIGS. 1A and 1B in use on an inside corner;

FIG. 5 is a schematic side view of another version of a caulking device of the invention in a loaded condition;

FIG. 6 is a schematic side view of the caulking device of FIG. 5 in use on a flat surface;

FIG. 7 is a schematic perspective view of the caulking device of FIG. 5 in use on a flat surface;

FIG. 8 is schematic bottom view of the caulking device of FIG. 5 in use on an inside corner;

FIG. 9 is a schematic side view of another version of a caulking device of the invention in a loaded condition;

FIG. 10 is a schematic side view of the caulking device of FIG. 9 in use on a flat surface;

FIG. 11 is a schematic perspective view of the caulking device of FIG. 9 in use on a flat surface;

FIG. 12 is schematic bottom view of the caulking device of FIG. 9 in use on an inside corner;

FIG. 13 is a schematic side view of another version of a caulking device of the invention in a loaded condition;

FIG. 14 is a schematic side view of another version of a caulking device of the invention in a loaded condition; and

FIG. 15 is a schematic side view of another version of a caulking device of the invention in a loaded condition.

### DESCRIPTION

The present invention relates to a caulking device. In particular, the invention relates to a caulking device with a supporting mechanism that may or may not be motorized. Although the invention is illustrated and described in the context of being useful for dispersing caulk, the present invention can be used in other ways, as would be readily apparent to those of ordinary skill in the art. Accordingly, the present invention should not be limited just to the examples and embodiments described herein.

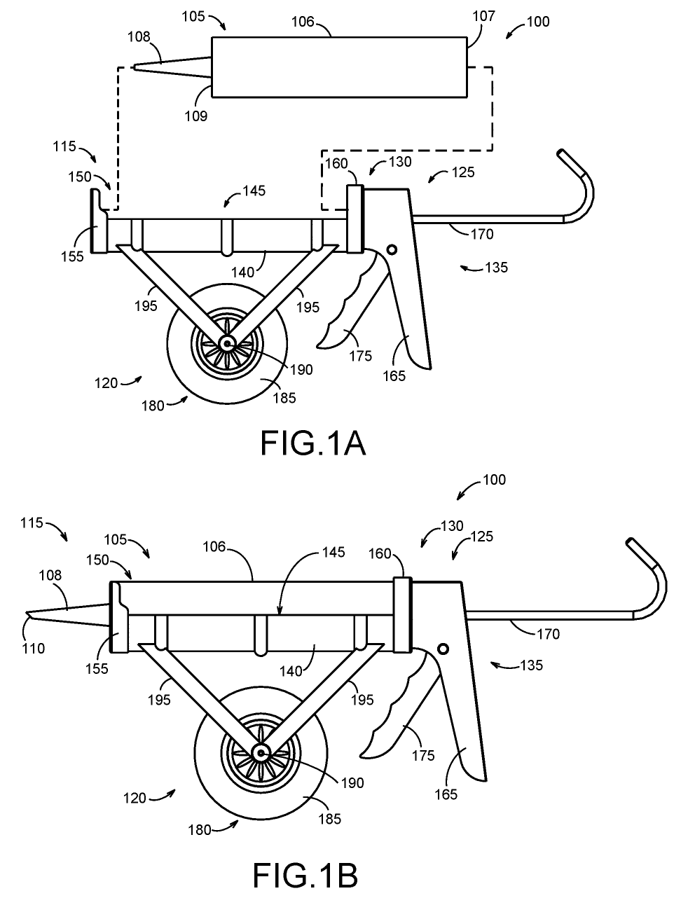

FIGS. 1A and 1B show a caulking device 100 according to a version of the invention. The caulking device 100 is used to disperse caulk or other material in a desired manner. By caulk it is meant a flexible material that can be used to seal a gap, such as a joint or seam, against the passage of moisture, air, dust, insects, heat, or the like, to act as an adhesive between two surfaces or materials, for decorative or aesthetic purposes, and the like. For example, caulk is commonly applied around windows, around bathroom, kitchen, and utility room fixtures, basins, and tubs, as tile grout or along the edges of tiled surfaces. A caulk typically comprises one or more sealing and/or adhesive compounds, such as acrylic, acrylic latex, polyurethane, silicone, and the like. Caulk is stored and dispersed in an uncured, flowable condition. Once dispersed, the caulk cures, such as by being exposed to oxygen, to a harder, less flexible condition where it can exist for months or years. Caulk is typically stored in a caulk container 105, such as a cartridge caulk tube 106, as shown in FIG. 1A. The cartridge caulk tube 106 has an internal chamber that extends from a rear end 107 to a sealed tip 108 that extends forwardly from a front wall 109 at the front end of the cartridge caulk tube 106, as is known in the art. To dispense the caulk, the cartridge caulk tube 106 is loaded into the caulking device 100 as shown by the dashed lines in FIG. 1A. Once loaded in the caulking device 100, as shown in the assembled view of FIG. 1B, a tip opening 110 is created, such as by cutting the tip 108 of the cartridge caulk tube 106. The uncured caulk within the internal cavity of the cartridge caulk tube 106 can then be dispensed by the caulking device 100, as will be explained.

The caulking device 100 comprises a caulk dispenser 115 and a supporting mechanism 120 adapted to support the caulk dispenser 115. By support it is meant that some of the weight of the caulking device 100 can be carried by the supporting mechanism 120 and/or the maintaining of an angular orientation of the caulking device 100 relative to a surface can be assisted. The caulk dispenser 115 comprises a dispensing mechanism 125 that is adapted to cause caulk from a caulk container 105 to be dispensed in a desired manner. The dispensing mechanism 125 can include any suitable caulk dispensing mechanism known in the art, such as a dispensing mechanism of a conventional caulk gun, as shown in the version of FIGS. 1A and 1B. In this version, the caulk dispenser 115 of the caulking device 100 comprises a cartridge holding body 130 and a dispensing actuator 135. The cartridge holding body 130 includes a longitudinally extending bottom wall 140 that may be rounded or otherwise shaped to correspond to the shape of the cartridge caulk tube 106. The bottom wall 140 at least partially defines a cartridge channel 145 that is sized and shaped to receive the cartridge caulk tube 106. The cartridge holding body 130 has an open top 150 that provides access to the cartridge channel 145 and into which the cartridge caulk tube 106 can be inserted so that it rests within the cartridge channel 145 and sits on the bottom wall 140. A front abutment 155 of the cartridge holding body 130 contacts the front wall 109 of the cartridge caulk tube 106 to prevent forward movement of the cartridge caulk tube 106 when it is received within the cartridge channel 145. The front abutment 155 can be U-shaped or have a vertical slot that receives the tip 108 of the cartridge caulk tube 106. Optionally the rear end 107 of the cartridge caulk tube 106 can be received within a closed portion 160 of the cartridge holding body 130 that has no open top 150 to help secure the cartridge caulk tube 106 within the cartridge channel 145. A handle portion 165 can be provided on the cartridge holding body 130 to allow a user to hold the cartridge holding body 130 and cartridge caulk tube 106. The dispensing actuator 135 in the version of FIGS. 1A and 1B comprises an arrangement that includes a spring-loaded push rod 170 that has at its forward end a pressure plate adapted to engage a displaceable member of the cartridge caulk tube 106 in a manner in which pressure applied to the displaceable member causes the displaceable member to move within the cartridge caulk tube 106 to reduce the volume of the interior chamber and thereby apply pressure to the uncured caulk therein which forces the uncured caulk to flow through the tip opening 110 so that the caulk is dispensed. A trigger member 175 is provided to advance the push rod 170 a desired amount so that a user can control the movement of the displaceable member of the cartridge caulk tube 106 and thereby control the flow of caulk out of the tip opening 110. As can be seen, in the version shown, the trigger member 175 is positioned so that it can be actuated by the fingers of a user that is grasping the handle portion165. A pressure release mechanism can be provided to release the pressure being applied by the push rod 170 and/or to allow rearward movement of the push rod 170, as is known in the art.

The caulking device 100 of the invention also comprises a supporting mechanism 120 connected to the cartridge holding body 130 or other portion of the caulk dispenser 115 of the caulking device 100. The supporting mechanism 120 comprises a surface contacting member 180, which in the version of FIGS. 1A and 1B is a wheel 185 that rotates about a wheel axis 190, and one or more support legs 195 that connect the surface contacting member 180 to the cartridge holding body 130. Alternatively, in another version, the surface contacting member 180 can comprise a plate or sliding member, as exemplified below. The supporting mechanism 120 is designed to support at least a portion of the weight of the caulking device 100 in use and/or to stabilize, guide, and/or control the caulking device 100 during the dispensing of caulk on a surface`.

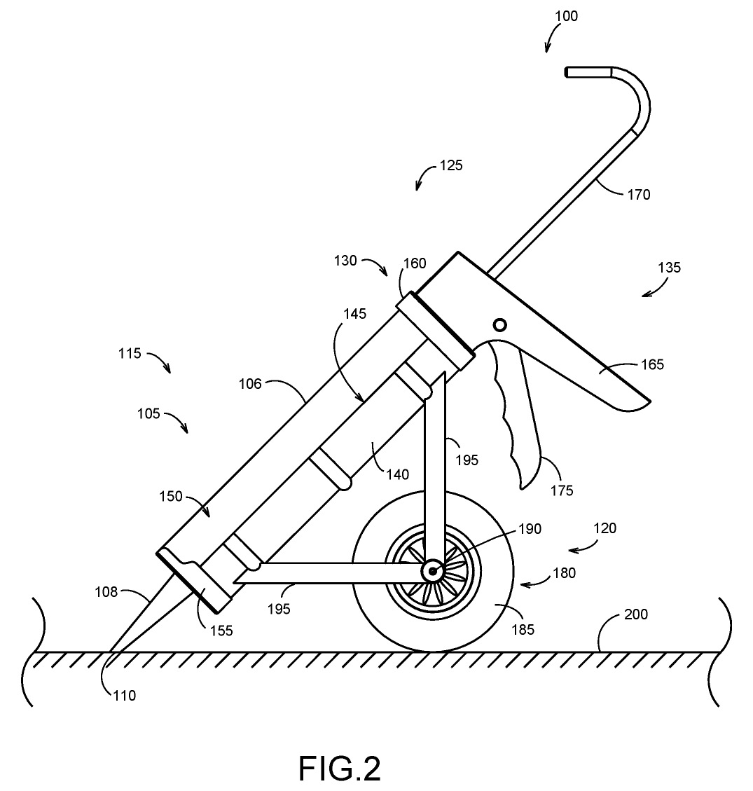

The caulking device 100 of FIGS. 1A and 1B is shown in operation in FIG. 2. FIG. 2 shows a surface 200 onto which caulk is to be applied. To apply the caulk, the supporting mechanism in positioned on the surface 200 so that the surface contacting member 180, in this case the wheel 185, contacts the surface 200. The caulk dispenser 115 of the caulking device 100 is then tilted as shown in FIG. 2 so that the tip opening 110 contacts or is just above the surface 200 at the location where caulk is to be applied. When properly positioned, the caulk can be dispensed from the caulk container 105, such as by depressing the trigger member 175 to cause the push rod 170 to force uncured caulk through the tip opening 110. Once the caulk is flowing, the caulking device can be pulled rearwardly, or from left to right in the view of FIG. 2, to create a line of caulk or caulk bead. By maintaining the angle of tilt of the caulking device 100 at a constant angle, a clean and consistent line of caulk can be easily created which is advantageous over using a caulking gun without a supporting mechanism where the angle needs to be maintained as consistent as possible by hand. This is particularly useful when a long caulk line is needed and/or when a large number of caulk lines are being produced, either of which can cause fatigue or lack of concentration which can result in a change of tilt angle and a resulting imperfection in the caulk line. Such an imperfection can lead to an improper seal and/or an unsightly blemish. In some cases, the imperfection can require repair or an entire reapplication of the line of caulk, which can be time consuming and costly.

The supporting mechanism 120 of the caulking device 100 can be designed to provide a desired angle of tilt. By angle of tilt it is meant the angle of a longitudinal central axis that extends through the cartridge channel 145 relative to a horizontal surface when the surface contacting member 180 is contacting the horizontal surface and the caulk disperser 115 of the caulking device 100 is tilted to a caulk dispensing position so that the tip opening 110 is contacting or just above, such as by less than about 0.1 inches, the horizontal surface. The caulking device 100 of course can be also used on non-horizonal surfaces, such as on vertical, angled and curved surfaces. In the version shown in FIGS. 1A, 1B, and 2, the angle of tilt is fixed at an angle from about 25 degrees to about 65 degrees, or about 40 degrees to about 50 degrees, or about 43 degrees to about 47 degrees. For most straight line caulk application purposes, a tilt angle of about 45 degrees is typically desired. However, a different tilt angle may be desired in some situations, such as when caulk is being applied to a rounded surface. For example, if a surface to be applied with caulk is an outwardly curved surface, the tilt angle of the caulking device 100 may need to be greater than 45 degrees, and if a surface to be applied with caulk is an inwardly curved surface, the tilt angle may need to be less than 45 degrees. In may also in some situations be desired to apply caulk at a tilt angle other than 45 degrees even on a flat surface. The tilt angle can also be dependent on the angle and/or position of the cut of the tip 108 to create the opening 110. For example, the opening 110 can be created at an angle so that that bottom edge of the opening 110 contacts the surface 200 during application. Therefore, the above ranges for the tilt angles are intended to include any such tip opening 110 configuration and/or position. In addition, the supporting mechanism 120 can be designed to provide the desired tilt angle, such as by altering the length of the one or more legs 195 and/or the size of the surface contacting member 180, such as by providing a wheel 185 of a different radius than shown. In another version, the tilt angle can be adjustable or selectable, such as by providing adjustable length legs 195 or by providing a set of different sized surface contacting members 180.

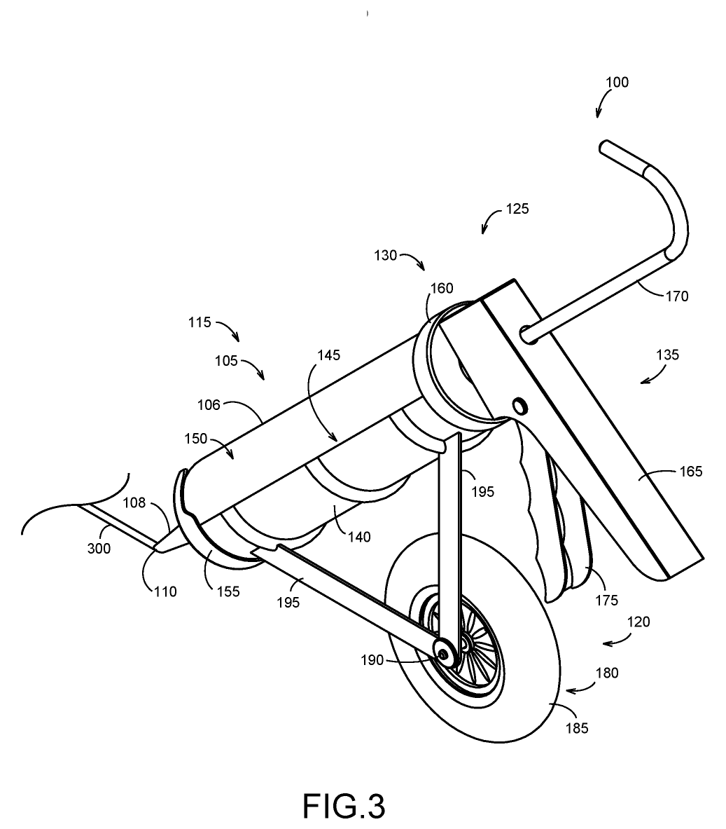

FIG. 3 shows a perspective view of the caulking device 100 of FIGS. 1A and 1B and FIG. 2 in use while applying a line of caulk 300. By using the caulking device 100 with a supporting mechanism 120 that positions the caulking device 100 at a consistent tilt angle, a nicely shaped and consistent line of caulk 300 results. In addition, by having the tilt angle easily maintained at a constant angle, the user can focus more on other application needs, such as the side-to-side angular orientation of the caulking device 100 and the speed of travel of the caulking device 100. With one less thing to worry about, such as the tilt angle, the user can be more deft with the other aspects of the application. The particular caulking device 100 of this version offers additional advantages as well. For example, as can be seen in FIG. 3, by providing a wheel 185 that has significant width, the side-to-side angular orientation of the caulking device 100 is more stable. Also, by designing the supporting mechanism 120 so that the wheel 185 is directly below the center of the cartridge holding body 130, the wheel 185 can serve as a guide for the placement of the line of caulk 300. Accordingly, a user can pull the caulking device 100 so that the wheel 185 rolls over the desired placement of the line of caulk 300 and the caulk will be dispersed along that line. In the particular version shown, this is accomplished by having the one or more legs 195 slight offset from the center of the cartridge holding body 130 so that the wheel 185 can be centered on a vertical plane that contains the longitudinal central axis that extends through the cartridge channel 145.

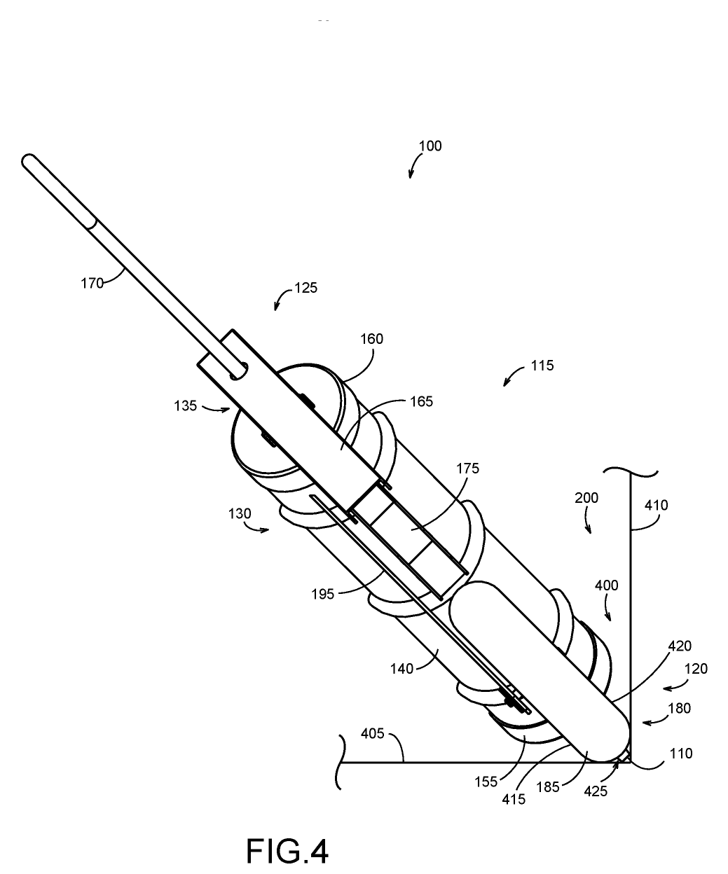

The alignment of the wheel 185 directly below the center of the cartridge holding body 130 is particularly advantageous when applying a line of caulk to an inside corner 400, as shown in FIG. 4. FIG. 4 shows an inside corner 400 formed at the junction of a first surface 405 and a second surface 410 that are oriented at an angle, such as a 90 degree or other angle, with respect to one another. To apply a line of caulk 300 along this inside corner 400, the wheel 185 can be positioned within the inside corner with a left outer surface 415 of the wheel 185 contact the first surface 405 and a right outer surface 420 of the wheel 185 contacting the second surface 410. As the caulking device 100 is pulled rearwardly while caulk is being dispersed from the tip opening 110, the wheel 185 is stabilized within the corner and the orientation of the tip opening 110 is thus stably maintained, both at a desired tilt angle and against side-to-side angular movement. Also, by having the width of the wheel be sufficiently wide, a space 425 is created under the wheel 185 so that the wheel 185 does not directly contact the inside corner 400. This is particularly useful when the caulking device 100 is passing over a line of caulk that has already been applied, such as when redoing a section of a line of caulk 300 or when two colinear lines of caulk 300 are being applied in opposite directions.

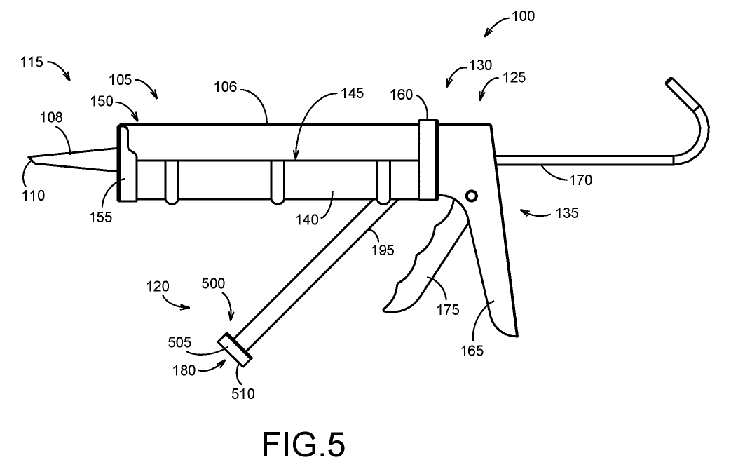

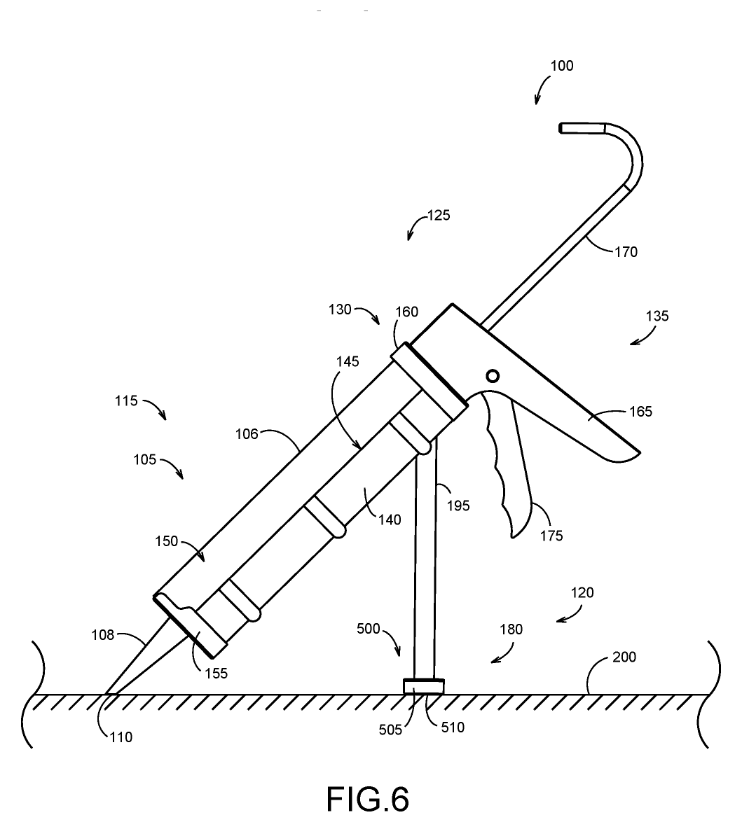

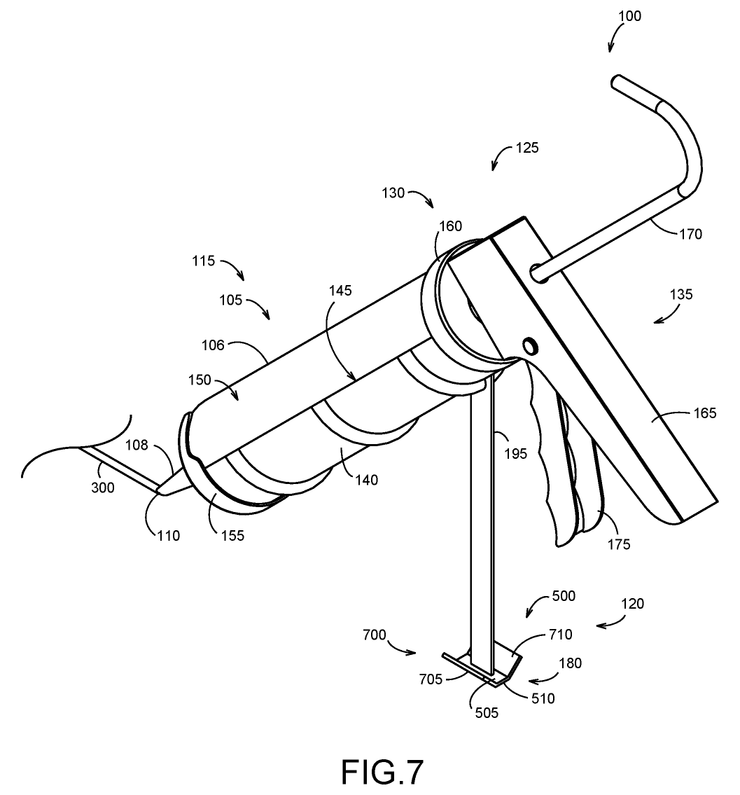

FIG. 5 shows another version of a caulking device 100 of the invention. The caulking device of FIG. 5 is similar to the caulking device of FIGS. 1A and 1B, however in the version of FIG. 5, the surface contacting member 180 comprises a sliding mechanism 500 in place of the wheel 185. In the particular version shown, the sliding mechanism 500 comprises a surface contacting body 505 that has a bottom surface 510 that can contact and slide along a surface 200 onto which a line of caulk 300 is to be applied, as shown in FIGS. 6 and 7. As can also be seen in FIG. 7, the surface contacting body 505 can also include a corner contacting slide mechanism 700. In the version shown, the corner contacting slide mechanism 700 comprise a first corner surface contacting wing 705 and a second corner surface contacting wing 710.

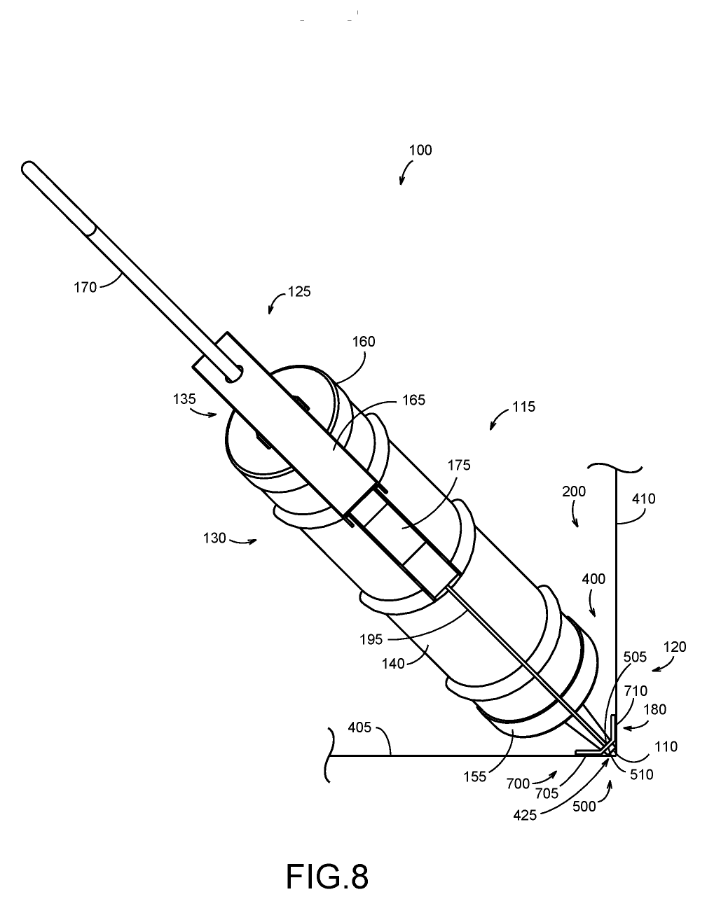

FIG. 8 shows the caulking device of FIG. 5 in use applying caulk to an inside corner 400 at the intersection of a first surface 405 and a second surface 410. As can be seen, in use the first corner surface contacting wing 705 contacts the first surface 405, and the second corner surface contacting wing 710 contacts the second surface 410 so that a the caulk can be controllably applied to the inside corner 400 as the sliding mechanism 500 slides rearwardly along the inside corner 400. As the caulking device 100 is pulled rearwardly while caulk is being dispersed from the tip opening 110, the sliding mechanism 500 is stabilized within the corner 400 and the orientation of the tip opening 110 is thus stably maintained, both at a desired tilt angle and against side-to-side angular movement. Also, by having the width of the flat bottom surface 510 be sufficiently wide, the space 425 is created under the surface contacting body 505 so that the surface contacting body 505 does not directly contact the inside corner 400. This is particularly useful when the caulking device 100 is passing over a line of caulk that has already been applied, such as when redoing a section of a line of caulk 300 or when two colinear lines of caulk 300 are being applied in opposite directions.

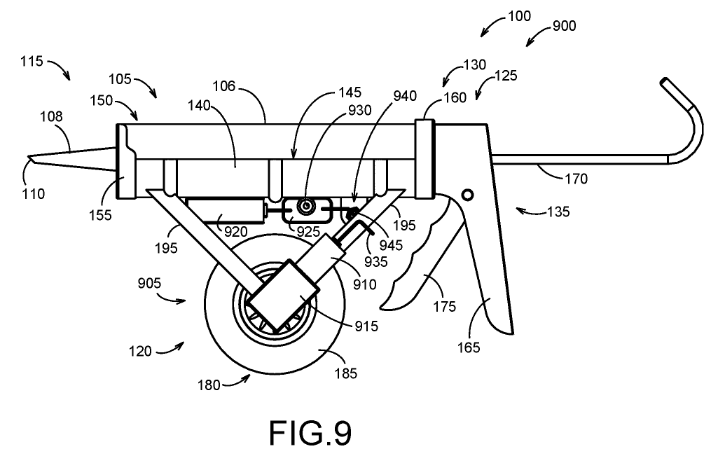

FIG. 9 shows another version of a caulking device 100 of the invention. The caulking device of FIG. 9 is similar to the caulking device of FIGS. 1A and 1B, however in the version of FIG. 9, the caulking device 100 is a self-propelled caulking device 900. In the version shown, the self-propulsion is accomplished by the surface contacting member 180 including a caulking device propelling mechanism 905. In the version shown, the caulking device propelling mechanism 905 The motorized surface contacting mechanism 905 comprises a motor 910 that drives a gear system 915 which is engageable with the wheel 185 in a manner that it can cause the wheel 185 to rotate when the motor 910 is activated.

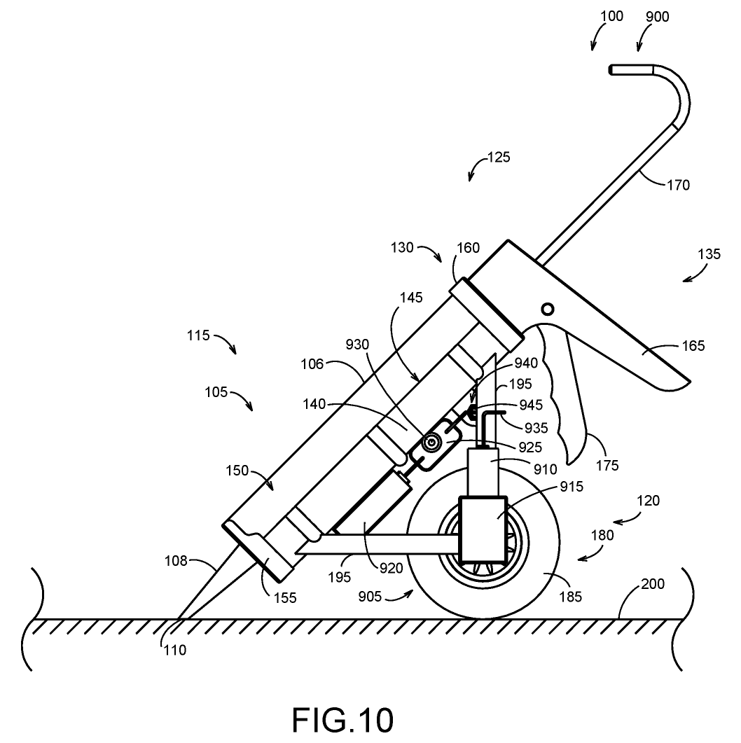

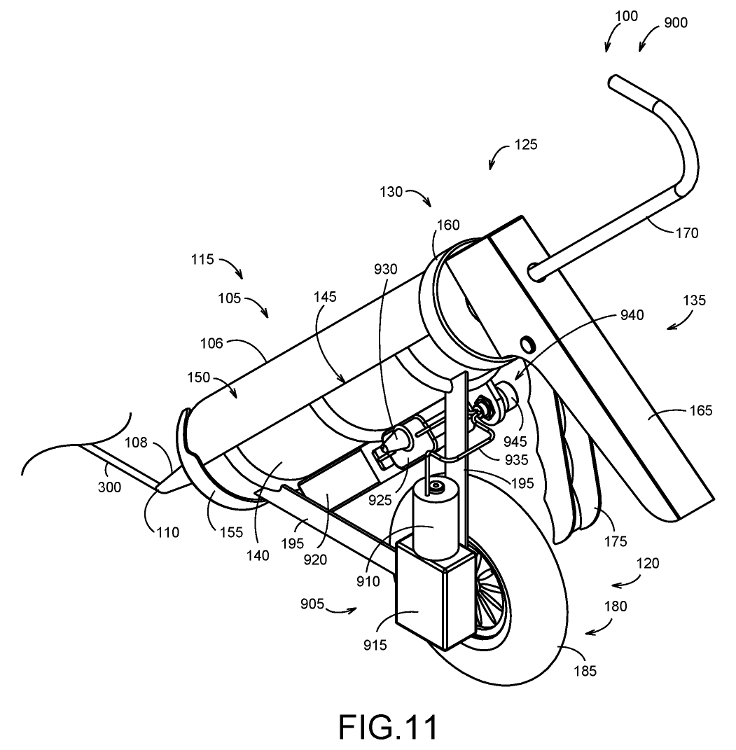

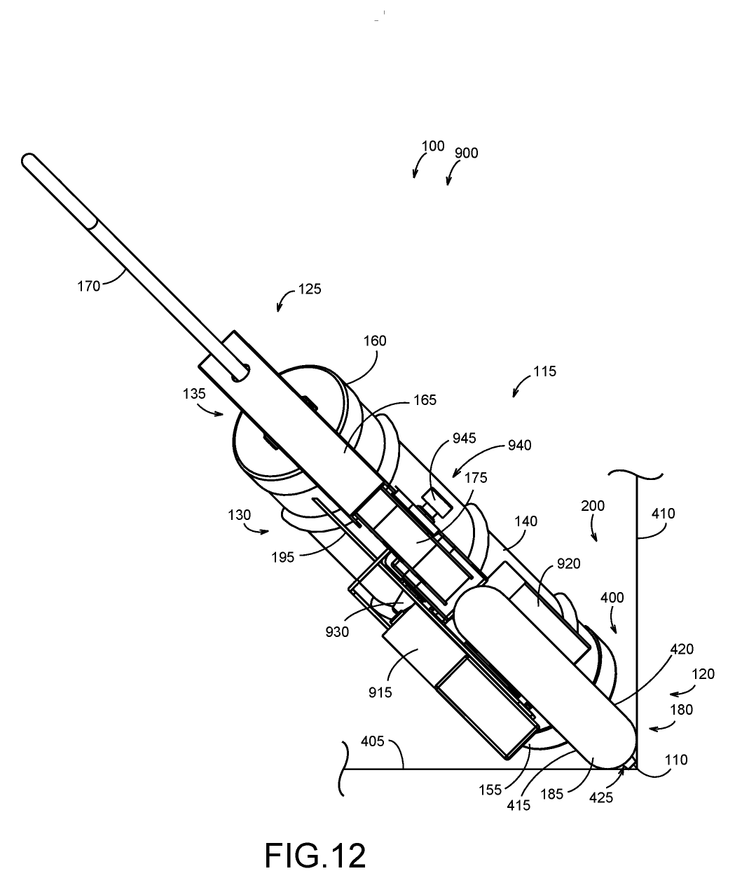

FIGS. 10 and 11 show the self-propelled caulking device 900 of FIG. 9 in operation. From the position of FIG. 10, activation of the motor 910 causes the wheel 185 to rotate in a clockwise manner. The clockwise rotation of the wheel 185 caused the wheel 185 to roll along the surface 200 and causes the caulking device 100 to move to the right. The self-propelled caulking device 900 can thus provide an improved manner of applying a line of caulk 300. When properly positioned, the caulk can be dispensed from the caulk container 105, such as by depressing the trigger member 175 to cause the push rod 170 to force uncured caulk through the tip opening 110. Once the caulk is flowing, the self-propelled caulking device 900 can be moved rearwardly by activation of the motor 910, to create the line of caulk 300 or caulk bead. This version of the caulking device 100 not only maintains the angle of tilt of the caulking device 100 at a constant angle, it also moves the caulking device 100 at a consistent speed so that a clean and consistent line of caulk can be easily created which is advantageous over using a caulking gun without a supporting mechanism and/or without self-propulsion where the angle needs to be maintained as consistent as possible by hand and the speed of movement needs to be maintained by hand as constant as possible. This is particularly useful when a long caulk line is needed and/or when a large number of caulk lines are being produced, either of which can cause fatigue or lack of concentration which can result in a change of tilt angle and/or the speed of movement and a resulting imperfection in the caulk line. Such an imperfection can lead to an improper seal and/or an unsightly blemish. In some cases, the imperfection can require repair or an entire reapplication of the line of caulk, which can be time consuming and costly. FIG. 12 shows the self-propelled caulking device 900 in operation on an inside corner 400.

A power source 920, such as a battery, can be provided to power the motor 910. Alternatively, the motor 910 can be connected to an external power supply. Optionally, a motor controller 925 can be provided so that the operation of the motor 910 can be controlled. For example, the motor controller 925 can be a speed controller that adjusts the speed of the motor 910 and thus controls the speed of revolution of the wheel 185 which this controls the speed of movement or propulsion of the caulking device 100. In the particular version shown, the motor controller comprises a potentiometer 930 that allows for adjustment of the voltage applied to the motor 910 to control the speed of operation of the motor. In one version, the speed of movement of the caulking device 100 can range from 30 inches per minute to about 180 inches per minute. One or more wires 935 can be provided to electrical signals to the various parts as necessary.

As also can be seen in the version of FIG. 9, the caulking device propelling mechanism 905 of the self-propelled caulking device 900 includes an activation system 940 that allows the motor 910 to be selectively activated. In the version of FIG. 9, the activation system 940 comprises an on/off switch 945 that is positioned to allow the flow of activating current to the motor 910 with in the on position and to prevent the flow of activating current to the motor 910 when in the off position. In use, a user can move the on/off switch 945 to the on position when the user desires to have the wheel 185 rotate and can move the on/off switch 945 to the off position when the user desires to have the wheel 185 stop rotating. For example, a user can position the caulking device 100 as shown in FIG. 10 and can then cause the caulk to flow from the caulk container 105 such as by depressing the trigger member 175. Once the caulk is flowing through the opening 110, the user can move the on/off switch 945 to the on position to active the motor 910 and cause the caulking device 100 to begin to move rearwardly. When the caulking is complete, the user can then move the on/off switch 945 to the off position. Alternatively, the user can elevate the wheel 185 off the surface 200 and cause the wheel 185 to rotate before caulk is flowing from the tip 110, and then once the caulk is flowing, the user can loser the wheel 185 onto the surface 200 so that the caulking device 100 moves rearwardly.

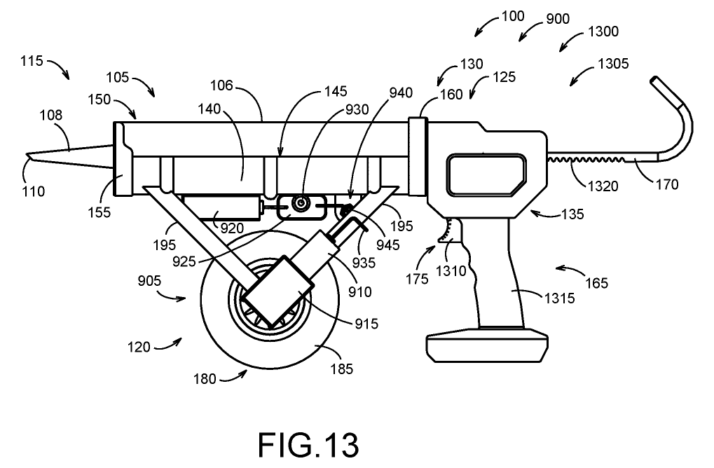

FIG. 13 shows another version of a caulking device 100 in the form of a self-propelled caulking device 900. In the version of FIG. 13, the caulking device 100 is a powered dispensing caulking device 1300. With the powered dispensing caulking device 1300, the dispensing mechanism 135 comprises, for example, a motorized dispensing mechanism 1305, such as a conventional motorized dispensing mechanism 1305 known in the art, such as a motorized dispensing mechanism 1305 as used in the RYOBI ONE+ 18V Cordless Caulk and Adhesive Gun and/or as described in one or more of United States Patent 4,615,469, United States Patent 6,488,180, and United States Patent 9,045,270, all of which are incorporated herein by reference in their entireties. Alternatively, the powered dispensing caulking device 1300 can comprises a non-motorized system, such as a pressure system as described in United States Patent 6,935,541, which is incorporated herein by reference in its entirety. In the version of FIG. 13, the trigger member 175 comprises a motorized comprises a motor trigger 1310 or the like on a handle body 1315 in place of the mechanical trigger of the version of FIGS. 1A and 1B. A dispensing motor is provided within the handle body 1315, and the dispensing motor causes movement of the push rod 170, such as by engaging teeth 1320 on the push rod 170, in a manner that causes caulk to be dispensed from the caulk container 105. The motorized dispensing mechanism 1305 is effective is dispensing a consistent amount of caulk from the open tip 110 when the motor trigger 1310 is depressed. To use the version of FIG. 13, the user can depress the motor trigger 1310 to begin the flow of caulk from the open top 110, and once flowing, the user can activate the motor 910 of the caulking device propelling mechanism 905, such as by moving the on/off switch 945 to the on position, and then operating the caulking device 100 as discussed above. The combination of a controlled angle of tilt, a consistent flow of caulk from the open tip 110, and a constant speed of rearward movement of the caulking device 100 results in a particularly clean line of caulk 300.

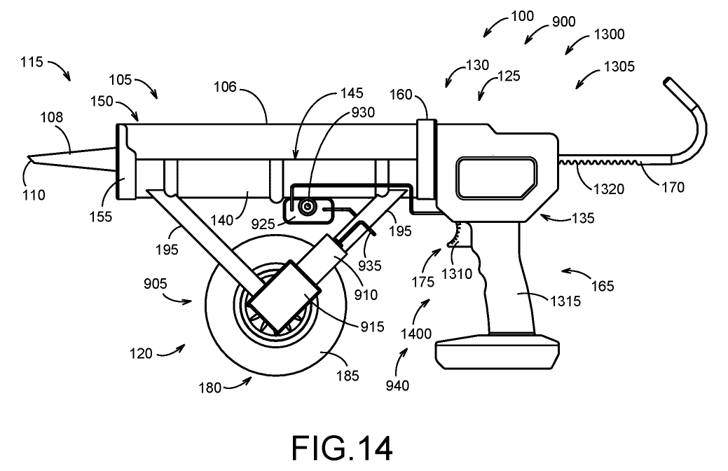

FIG. 14 shows another version of a caulking device 100 in the form of a self-propelled caulking device 900 and motorized dispensing caulking device 1300. In the version of FIG. 14, the activation system 940 of the caulking device propelling mechanism 905 comprises an automatic activation mechanism 1400. With this version, the on/off switch 945 is replaced by the automatic activation mechanism 1400 which causes rotation of the wheel 185 automatically. For example, in the particular version of FIG. 14, the automatic activation mechanism 1400 automatically starts the rotation of the wheel 185 when the motor trigger 1310 is depressed. Thus, with a single touch, a user can cause both the dispensing of the caulk and the movement of the self-propelled caulking device 900. As can also be seen in the version of FIG. 14, the power source 920 for the motor 910 can be the same as the power source that powers the motorized dispensing mechanism 1305, such as a battery or rechargeable battery in the handle body 1315.

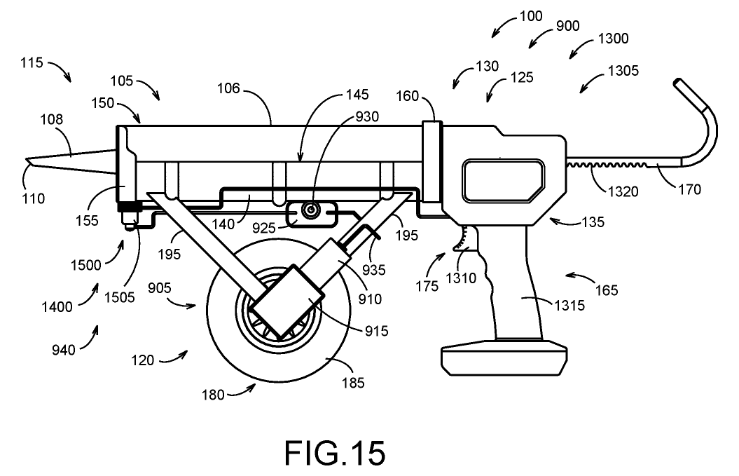

FIG. 15 shows another version of a caulking device 100 in the form of a self-propelled caulking device 900 and motorized dispensing caulking device 1300 with an automatic activation mechanism 1400. In this version, the automatic activation mechanism 1400 comprises a caulk flowing sensing system 1500 that detects when caulk is flowing from the caulk container 105 and/or when there is sufficient pressure for caulk to flow from the caulk container 105. For example, in the particular version of FIG. 15, the caulk flowing sensing system 1500 comprises a pressure sensor 1505 positioned to detect when the cartridge caulk tube 106 is being pressed against the front abutment 155, thereby indicating that the push rob 170 is pressing against the rear end 107 of the cartridge caulk tube 106.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/- ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A caulking device comprising:
a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and
a supporting mechanism connected to the caulk container holding body, the supporting mechanism comprising a surface contacting member adapted to contact a surface onto which caulk is to be applied,
wherein the support mechanism is adapted to orient the caulk dispenser at a predetermined and consistent angle of tilt during the dispensing of the caulk.

2. A caulking device according to claim 1 wherein the supporting mechanism comprises a wheel.

3. A caulking device according to claim 1 wherein the supporting mechanism is adapted to orient the caulk dispenser at an angle of tilt of from about 25 degrees to about 65 degrees, wherein the angle of tilt is the angle of a longitudinal central axis extending through a caulk container channel of the caulk container holding body relative to a horizontal surface when the surface contacting member is contacting the horizontal surface and the caulk disperser is tilted to a caulk dispensing position.

4. A caulking device according to claim 1 wherein the supporting mechanism comprises a wheel, wherein the wheel comprises a left outer surface and a right outer surface, and wherein the left outer surface and right outer surface are sized and shaped so that the left outer surface contacts a first surface of an inside corner onto which caulk is to be applied and the right outer surface contacts a second surface of the inside corner.

5. A caulking device according to claim 1 wherein the supporting mechanism comprises a wheel, wherein the wheel comprises a left outer surface and a right outer surface, and wherein the left outer surface and right outer surface are sized and shaped so that the left outer surface contacts a first surface of an inside corner onto which caulk is to be applied and the right outer surface contacts a second surface of the inside corner and wherein a sufficient amount of space is provided between the wheel and the inside corner that the wheel does not contact caulk that has been applied to the inside corner.

6. A caulking device according to claim 1 wherein the supporting mechanism comprises a caulking device propelling mechanism adapted to cause the caulking device to move relative to a surface in the direction of the application of caulk on the surface.

7. A caulking device according to claim 1 wherein the supporting mechanism comprises a caulking device propelling mechanism adapted to cause the caulking device to move relative to a surface in the direction of the application of caulk on the surface, and wherein the caulking device propelling mechanism comprises a wheel and a motor adapted to cause the wheel to rotate.

8. A caulking device according to claim 1 wherein the supporting mechanism comprises a caulking device propelling mechanism adapted to cause the caulking device to move relative to a surface in the direction of the application of caulk on the surface, and wherein the caulking device propelling mechanism comprises a speed controller adapted to adjustably control the speed the caulking device moves relative to the surface.

9. A caulking device according to claim 1 wherein the supporting mechanism comprises a caulking device propelling mechanism adapted to cause the caulking device to move relative to a surface in the direction of the application of caulk on the surface, and wherein the caulking device propelling mechanism comprises an activation system adapted to selectively activate the caulking device propelling mechanism.

10. A caulking device according to claim 1 wherein the supporting mechanism comprises a caulking device propelling mechanism adapted to cause the caulking device to move relative to a surface in the direction of the application of caulk on the surface, and wherein the caulking device propelling mechanism comprises an activation system adapted to automatically activate the caulking device propelling mechanism when caulk is being dispensed by the caulking device.

11. A caulking device comprising:
a caulk dispenser comprising a caulk container holding body and a dispensing mechanism, wherein the caulk container holding body is adapted to receive a caulk container and wherein the dispensing mechanism is adapted to cause caulk within the caulk container to be dispensed from the caulk container when the dispensing mechanism is actuated; and
a propelling mechanism adapted to cause the caulking device to move relative to a surface onto which caulk is to be dispensed from the caulking device,
wherein the propelling mechanism causes the caulking device to move in the direction of the application of caulk on the surface.

12. A caulking device according to claim 11 wherein the caulking device propelling mechanism comprises a wheel and a motor adapted to cause the wheel to rotate.

13. A caulking device according to claim 11 wherein the caulking device propelling mechanism comprises a wheel and a motor adapted to cause the wheel to rotate, wherein the wheel is adapted to orient the caulk dispenser at an angle of tilt of from about 25 degrees to about 65 degrees, and wherein the angle of tilt is the angle of a longitudinal central axis extending through a caulk container channel of the caulk container holding body relative to a horizontal surface when the surface contacting member is contacting the horizontal surface and the caulk disperser is tilted to a caulk dispensing position.

14. A caulking device according to claim 11 wherein the caulking device propelling mechanism comprises a speed controller adapted to adjustably control the speed the caulking device moves relative to the surface.

15. A caulking device according to claim 11 wherein the caulking device propelling mechanism comprises an activation system adapted to selectively activate the caulking device propelling mechanism.

16. A caulking device according to claim 11 wherein the caulking device propelling mechanism comprises an activation system adapted to automatically activate the caulking device propelling mechanism when caulk is being dispensed by the caulking device.

17. A method of applying caulk to a surface, the method comprising:
providing a caulking device comprising a caulk dispenser and a supporting mechanism connected to the caulk dispenser, wherein the caulk dispenser comprises a caulk container holding body and a dispensing mechanism;
loading a caulk container into the caulk container holding body;
activating the dispensing mechanism to cause caulk to be dispensed out of the caulk container and applied onto the surface; and
contacting the surface with the supporting mechanism to support the caulking device on the surface and to maintain a consistent angle of tilt during the application of caulk onto the surface.

18. A method according to claim 17 wherein the supporting mechanism is adapted to orient the caulk dispenser so that caulk is dispensed at a supported angle of tilt of from about 25 degrees to about 65 degrees.

19. A method according to claim 17 wherein the supporting mechanism comprises a caulking device propelling mechanism adapted to cause the caulking device to move relative to a surface in the direction of the application of caulk on the surface.

20. A caulking device according to claim 17 wherein the supporting mechanism comprises a caulking device propelling mechanism adapted to cause the caulking device to move relative to a surface in the direction of the application of caulk on the surface, and wherein the caulking device propelling mechanism comprises an activation system adapted to automatically activate the caulking device propelling mechanism when caulk is being dispensed by the caulking device.
